(19) United States
(12) Patent Application Publication
(10) Pub. No.: US 2026/0016731 A1
(43) Pub. Date: Jan. 15, 2026

(54) OPTICAL FILTERING DEVICE AND METHOD OF TUNING THE SAME

(71) Applicant: SAMSUNG ELECTRONICS CO., LTD., Suwon-si (KR)

(72) Inventors: Aleksandr Sergeevich SHOROKHOV, Moscow (RU); Anton Sergeevich Medvedev, Krasnozavodsk (RU); Maxim Vladimirovich Ryabko, Dolgoprudny (RU)

(73) Assignee: SAMSUNG ELECTRONICS CO., LTD., Suwon-si (KR)

(21) Appl. No.: 19/266,714

(22) Filed: Jul. 11, 2025

(30) Foreign Application Priority Data
Jul. 12, 2024 (RU) 2024119621
Mar. 31, 2025 (KR) 10-2025-0041438

(51) Int. Cl. G02F 1/21; G02F 1/01; G02F 1/225

(52) U.S. Cl. CPC G02F 1/212; G02F 1/0147; G02F 1/225; G02F 2203/15

(57) ABSTRACT

Provided is an optical filtering device including a microring resonator including one or more partial regions covered with a phase change material (PCM) section, a first waveguide including a first interferometric arm including a region covered with a PCM, wherein radiation is input to and output through the first waveguide, and a second waveguide including a second interferometric arm including a region covered with a PCM, wherein radiation is input to and output through the second waveguide.

### CROSS-REFERENCE TO RELATED APPLICATION

This application is claims priority to Russian Patent Application No. 2024119621, filed on Jul. 12, 2024, in the Russian Patent Office and Korean Patent Application No. 10-2025-0041438, filed on Mar. 31, 2025, in the Korean Intellectual Property Office, the disclosures of which are incorporated by reference herein in their entireties.

### BACKGROUND

### 1. Field

Embodiments of the present disclosure relate to an optical filtering device and a method of tuning the optical filtering device, and more particularly, to a non-volatile, reconfigurable, optical filtering device and a method of tuning the optical filtering device.

### 2. Description of Related Art

Various optical filtering devices based on electronic-photonic integrated circuits (EPIC) have been used. For example, optical filtering devices may be used for various applications in electronic-photonic hardware (HW) accelerators used for machine learning, in photonic interconnects (for optical interconnections for data centers), and for various types of optical signal processing in telecommunication systems. Requirements may be imposed on optical filtering devices based on their applications as follows.

Optical filtering devices may adjust a bandwidth by various means. For example, the optical properties of optical filtering devices may be adjusted by performing thermal tuning by adjusting the temperature by applying an external voltage to metal contacts provided on optical filtering devices or by performing injection tuning by means of an external voltage applied to charge carriers (electrons or holes) in a semiconductor device. However, such thermal tuning and injection tuning may require constant energy consumption to maintain the required settings.

### SUMMARY

One or more embodiments provide an optical filtering device and a method of tuning the optical filtering device capable of maintaining a given setting of parameters without an additional energy supply to the optical filtering device.

One or more embodiments also provide an optical filtering device and a method of tuning the optical filtering device capable of independently controlling a resonance shift with respect to a spectrum of radiation passing through the optical filtering device in interferometric arms of a waveguide and a microring resonator.

One or more embodiments also provide an optical filtering device and a method of tuning the optical filtering device capable of changing the amplitude of a spectrum of radiation passing through the optical filtering device without shifting a resonance with respect to the spectrum in interferometric arms of a waveguide and a microring resonator.

One or more embodiments also provide an optical filtering device implemented in a small form-factor (SFF) to minimize an installation space located in an optical chip and a method of tuning the optical filtering device.

One or more embodiments provide an optical filtering device and a method of tuning the optical filtering device capable of reducing inter-channel crosstalk in the optical filtering device in which radiation with a narrow spectrum of wavelengths is used.

One or more embodiments provide an optical filtering device and a method of tuning the optical filtering device, which require low power consumption for performing spectral tuning during the repeated use of the optical filtering device.

Additional aspects will be set forth in part in the description which follows and, in part, will be apparent from the description, or may be learned by practice of embodiments of the disclosure.

According to an aspect of one or more embodiments, there is provided an optical filtering device including a microring resonator including a first region, a phase change material (PCM) being on the first region, a first waveguide including a first interferometric arm and configured to receive and output radiation, the first interferometric arm including a second region, a PCM being on the second region, and a second waveguide including a second interferometric arm and configured to receive and output radiation, the first interferometric arm including a third region, a PCM being on the third region, wherein the microring resonator is between the first waveguide and the second waveguide, and a region of the first interferometric arm and a region the second interferometric arm are adjacent to the microring resonator and configured to provide optical coupling with the microring resonator, wherein a phase of radiation of a predetermined wavelength that passes through each of the first interferometric arm and the second interferometric arm is a multiple of 2πn, where n is an integer, of a phase of radiation that passes through a region of the microring resonator between the region of the first interferometric arm and the region of the second interferometric arm configured to provide optical coupling with the microring resonator, and wherein each of the PCM respectively on the microring resonator, the first interferometric arm, and the second interferometric arm are configured to provide a predetermined effective refractive index at the predetermined wavelength and provide at least one of a resonance shift of radiation and an amplitude change of radiation at the predetermined wavelength propagating in the first waveguide or the second waveguide.

The optical filtering device may further include an external radiation source configured to generate pulsed initial radiation on the first waveguide or the second waveguide.

The first interferometric arm, the second interferometric arm, and a portion of the microring resonator between the region of the first waveguide and the region of the second waveguide configured to provide optical coupling with the microring resonator are Mach-Zehnder interferometers.

The optical filtering device my further include a detector configured to measure an output of an optical signal at an input side or an output side of the first waveguide or the second waveguide.

The optical filtering device may further include a local PIN thermoheater configured to individually adjust a phase state of each of the PCM respectively on the microring resonator, the first interferometric arm, and the second interferometric arm.

The PIN thermoheater may include a voltage source connected by two electrical contacts to doped regions in a silicon layer on a substrate, and the two electrical contacts may be spaced at a predetermined distance from each of the microring resonator, the first interferometric arm, and the second interferometric arm.

The two electrical contacts may include a contact region configured to apply voltage from a voltage source to doped regions.

Each of the PCM respectively on the first interferometric arm and the second interferometric arm may be configured to provide a spectral resonance shift and a change in spectral amplitude, and the PCM on the microring resonator may be configured to provide a spectral resonance shift.

The spectral resonance shifts provided in the PCM respectively on the first interferometric arm and the second interferometric arm may be configured to be compensated by the spectral resonance shift provided in the PCM on the microring resonator, such that a change is provided in the spectral amplitude while a spectral position of resonance is unchanged in a process of propagating radiation of the predetermined wavelength.

Each of the PCM respectively on the microring resonator, the first interferometric arm, and the second interferometric arm may include a continuous PCM layer.

Each of the PCM respectively on the microring resonator, the first interferometric arm, and the second interferometric arm may have a predetermined pattern shape or an arbitrary pattern shape.

The predetermined pattern shape or the arbitrary pattern shape may include a PCM divided into at least two portions.

The first waveguide and the second waveguide may be single-mode ridge waveguides or strip waveguides.

The microring resonator may be a closed loop ring resonator.

According to another aspect of one or more embodiments, there is provided a method of tuning an optical filtering device including a first waveguide including a first interferometric arm, a second waveguide that includes a second interferometric arm, a microring resonator between the first waveguide and the second waveguide, and phase change material (PCM) on the first waveguide, the second waveguide, and the microring resonator, the method including tuning each PCM respectively on the microring resonator, the first interferometric arm, and the second interferometric arm, wherein the tuning of each of the PCM sections includes performing thermal injection on each of the PCM to provide a predetermined partial crystallization of at least a portion of the PCM to change a phase state of at least a portion of the PCM, such that a predetermined change is caused in the effective refractive index in the PCM at a predetermined wavelength, determining the phase state of at least a portion of the PCM by a coefficient α indicating a proportion of a crystalline phase and an amorphous phase in at least a portion of the PCM, the coefficient α being determined by: α=vₐ/(vₐ+v_{c}), where vₐ is a volume of the amorphous phase, and v_{c} is a volume of the crystalline phase, wherein each of the PCM sections respectively on the microring resonator, the first interferometric arm, and the second interferometric arm is tuned to provide a predetermined effective refractive index for radiation at the predetermined wavelength to provide any one of a resonance shift and an amplitude change of radiation at the predetermined wavelength propagating in the first waveguide or the second waveguide.

The tuning of the effective refractive index at the predetermined wavelength in each of the PCM sections may be configured to change a phase velocity of propagation of an optical signal.

Thermal injection on each of the PCM may be performed by applying a predetermined voltage to doped regions through two electrical contacts of the PIN thermoheater.

The thermal injection on the PCM respectively on the microring resonator, the first interferometric arm, and the second interferometric arm may be performed simultaneously or the thermal action on the PCM respectively on the microring resonator, the first interferometric arm, and the second interferometric arm is individually performed at different times.

The predetermined voltage may be in a range of 1 V to 10 V.

The predetermined voltage may be applied for 500 ns to 100 ms and with a duty cycle of up to 1 second between pulses.

### BRIEF DESCRIPTION OF DRAWINGS

The above and other aspects, features, and advantages of embodiments of the disclosure will be more apparent from the following description taken in conjunction with the accompanying drawings, in which:

FIG. 1a shows graphs illustrating transmission spectra of light waves during thermal tuning on a microring resonator based on a configuration of an interferometer with upper and lower interferometric arms of related embodiment;

FIG. 1B shows tuning curves of a microring resonator of related embodiment;

FIG. 1C shows graphs illustrating transmission spectra of light waves during thermal tuning on a microring resonator of the related embodiment;

FIG. 1D shows tuning curves of a microring resonator of the related embodiments;

FIG. 2 is a top view of a microring resonator of the related embodiment;

FIG. 3A is a top view of a microring resonator with waveguides of the related embodiment;

FIG. 3B shows a magnified microscope image of a real structure from a portion of the microring resonator shown in FIG. 3A;

FIG. 4 shows a resonance profile of a microring resonator of the related embodiment;

FIG. 5A is a schematic top view of an optical filtering device according to one or more embodiments;

FIG. 5B is a cross-sectional view of a microring resonator in phase change material (PCM) sections according to one or more embodiments;

FIG. 6A is a graph illustrating signal transmission in an optical filtering device when using a Sb₂S₃ material in a PCM section, according to the phase state (amorphous or crystalline) of the PCM according to one or more embodiments;

FIG. 6B schematically illustrates amorphous (a-Sb₂S₃) and crystalline (c-Sb₂S₃) states of the PCM section of the material after thermal exposure to the PCM section, according to one or more embodiments;

FIG. 7A schematically shows a top view of an optical filtering device according to one or more embodiments;

FIG. 7B shows a cross-section of a PCM section and adjacent portions according to one or more embodiments;

FIG. 7C shows a cross-section of a substrate, a PCM section, and adjacent portions according to one or more embodiments;

FIG. 8A is a top view of an optical filtering device according to one or more embodiments;

FIG. 8B is a top view of an optical filtering device according to one or more embodiments;

FIG. 9A shows an image of an amplitude of a wave in a cross section of a waveguide with a PCM section including a Sb₂S₃ material in an amorphous state according to one or more embodiments;

FIG. 9B shows an image of an amplitude of a wave in a cross section of a waveguide with a PCM section including a Sb₂S₃ material in an amorphous state according to one or more embodiments;

FIG. 10 shows curves illustrating dependence of radiation transmission at a predetermined (selected) wavelength of 1545 nm passing through a reconfigurable, optical filtering device on the phase state of the material, according to one or more embodiments;

FIGS. 11A, 11B, and 11C schematically show microring resonators according to one or more embodiments;

FIG. 12A shows a resonant profile of an optical filtering device including a microring resonator and interferometer arms; and

FIG. 12B shows a resonant profile of the optical filtering device using elliptical resonators.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It should be appreciated that various embodiments of the disclosure and the terms used therein are not intended to limit the technological features set forth herein to particular embodiments of the disclosure, and include various changes, equivalents, or alternatives for a corresponding embodiment.

With reference to descriptions of drawings, similar reference numerals may be used to refer to similar or related elements.

It is to be understood that a singular form of a noun corresponding to an item may include the item or a plurality of the items, unless the context clearly indicates otherwise.

As used herein, expressions such as “A or B”, “at least one of A and B”, “at least one of A or B”, “A, B or C”, “at least one of A, B, and C”, “at least one of A, B, or C” may include any one of, or all available combinations of the items enumerated together in a corresponding one of the phrases.

Terms such as “1^{st}” and “2^{nd}” or “first” and “second” may be used to simply distinguish a corresponding element from another, and does not limit the elements in other aspect (e.g., importance or order).

When an element (e.g., a first element) is referred to, with or without the term “operatively” or “communicatively”, as being “coupled with,” “coupled to,” “connected with,” or “connected to” another element (e.g., a second element), it means that the element may be connected to the other element directly (e.g., in a wired manner), wirelessly, or via a third element.

As used here, such terms as “comprises,” “includes,” or “has” specify the presence of stated features, numbers, stages, operations, elements, parts, or a combination thereof, but do not preclude the presence or addition of one or more other features, numbers, stages, operations, elements, parts, or a combination thereof.

When an element is referred to as being “connected to,” “coupled to,” “supported by,” or “in contact with” another element, it means that the element is directly connected to, coupled to, supported by, or in contact with the other element, or that the element is indirectly connected to, coupled to, supported by, or in contact with the other element via a third element.

When an element is referred to as being “on” another element, it means that the element is in contact with the other element, or that still another element is present between the element and the other element.

As used herein, the term “and/or” includes any one or a combination of a plurality of related recited elements.

Hereinafter, an operation principle of the disclosure and one or more embodiments will be described with reference to the accompanying drawings.

In microring resonators of the related embodiment, inter-channel crosstalk may increase because a resonance shift causes a change in the intensity of adjacent channels. In addition, in the microring resonators of the related embodiment, power consumption during operation is relatively high because an external adjustment needs to be added to control the transmission of optical signals.

However, for a clearer understanding of the shortcomings of optical filter devices of the related embodiment based on a microring resonator, it is necessary to confirm the basic design principles of formation of the resonator and processes occurring in the microring resonator. The optical filter device may include a set of waveguides operating at several wavelengths, in which at least one is a closed loop in the form of a ring. The closed loop is optically coupled with another waveguide located next to the ring, which serves as the input and output of light for the optical filtering device. Optical coupling in this case may be performed due to the near electromagnetic field at a small distance between the waveguides (usually less than the wavelength of radiation). Due to the presence of optical coupling between the closed loop in the form of the ring and the waveguide, a partial transfer of energy occurs in the ring, which is characterized both by a radius of the closed loop and by a coupling coefficient. The coupling coefficient may be determined by a gap between the waveguide into which radiation is supplied and the microring resonator. The smaller the gap between the waveguide and the microring resonator, the higher the optical coupling, because an electric field outside the waveguide decays exponentially. This effect of energy transfer in the microring resonator may be used for both passive and active filtering.

The operation of the microring resonator is based on the interference of light and internal reflection. For example, when light with several carrier wavelengths is passed through a loop of the microring resonator from one waveguide (e.g. a first waveguide), the light intensity increases with multiple passes and is output through another waveguide (e.g., a second waveguide). Because only a few selected wavelengths are in the resonance within the loop, the microring resonator functions as a filter.

A narrow spectrum of wavelengths may be used in the field of telecommunications, and commercially available optical filters using waveguides operate at several wavelengths. A distance between the narrow spectrum of wavelengths is less than 1 nm, which may initiate the occurrence of inter-channel interference between working channels. At the same time, a modification of the optical characteristics of the working channels by means of thermal tuning or injection tuning, for example, an increase in a transmission rate (transmission T) of the channels, entails resonance shifts, which also fall under a working wavelengths λ, however, adjusting the transmission rate at a certain wavelength requires keeping a resonance position at this wavelength unchanged. As described above, the modification of the optical characteristics of the working channels may be very difficult to achieve in a commercially available optical filtering device operating in a wavelength division multiplexing (WDM) telecommunication system.

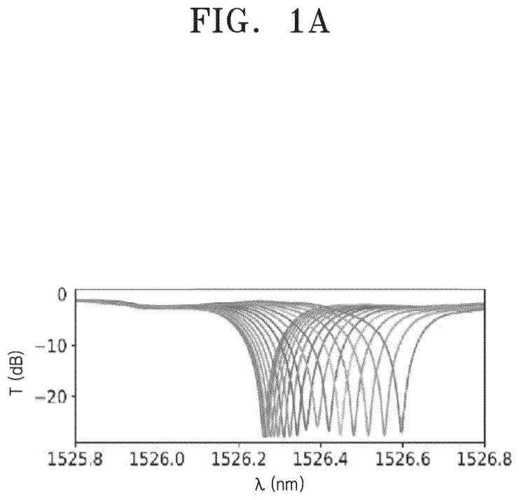

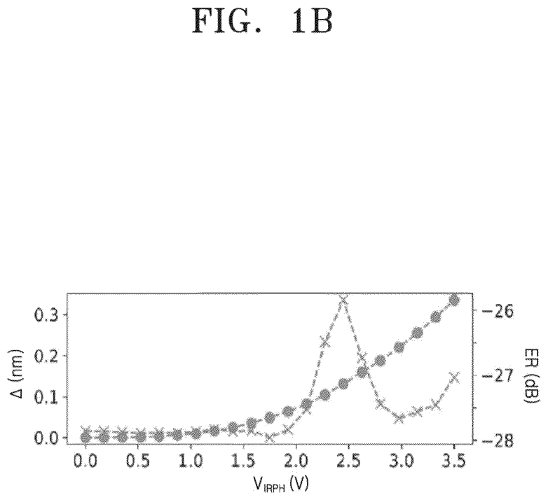

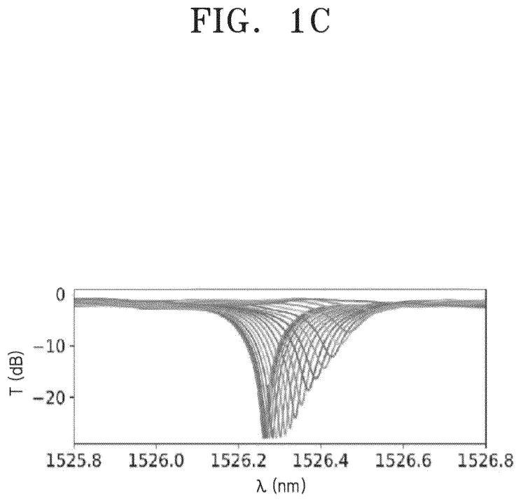

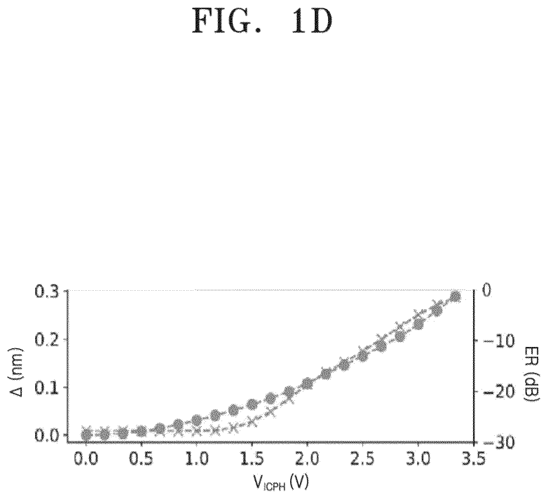

FIG. 1A shows graphs illustrating transmission spectra of light waves during thermal tuning on a microring resonator based on a configuration of an interferometer with upper and lower interferometric arms of the related embodiment.

Referring to FIG. 1A, the X-axis shows a wavelengths of radiation λ propagating through the microring resonator, and the Y-axis shows the transmission T. The parameter T—transmission showing an operation of a filter as a whole is a ratio between power of the radiation incident on the filter and the radiation that has passed through the filter (the latter divided by the former). The parameter T represents a transfer function

Modification of the optical characteristics of a telecommunication device is achieved through thermal tuning or injection tuning in the microring resonator when the transmission changes. In FIG. 1A, values 0, −10, and −20 are shown on the Y-axis as the transmission T (dB), which are logarithmic representations of the power of a transmitted signal and correspond to: 0 dB on the graph is equivalent to 1 mW of laser power, −10 dB is equivalent to 0.1 mW of laser power, −20 dB is equivalent to 0.01 mW. As shown in FIG. 1A, there is a shift in the optical resonance lines, causing inter-channel interference in the telecommunication system, which may affect the transmission intensity in neighboring spectral channels.

FIG. 1B shows tuning curves of a microring resonator of the related embodiment.

A resonance center wavelength shift curve Δ (the curve as a dotted line—corresponding to values on the Y-axis on the left) and an extinction ratio ET change curve (the curve as a dotted line and crosses—corresponding to values on the Y-axis on the right) are a function of a voltage V_{IRPH} applied to a heater in an inner loop (in-resonator photoconductive heater (IRPH)) of the microring resonator based on the configuration of the interferometer with upper and lower interferometric arms from the related embodiment. When a wavelength range is about 1525.8 nm to about 1526.8 nm, then the value of 1526.25 nm may be considered as a center wavelength.

Referring to FIG. 1B, the position of a resonance wavelength may be modified, while changing the extinction ratio ER of the selected resonance, by applying a voltage to an inner loop or an outer loop of the optical filtering device. Here, the outer loop is an interferometer loop, and the inner loop is a resonator. In this case, FIG. 1B shows a variant of the effect of the voltage V_{IRPH} applied to the heater in the inner loop (in-resonator photoconductive heater (IRPH)) of the microring resonator.

FIG. 1C shows graphs illustrating transmission spectra of light waves during thermal tuning on a microring resonator of the related embodiment.

Referring to FIG. 1C, the microring resonator is based on the configuration of an interferometer with upper and lower interferometric arms, where the X-axis shows the wavelengths of the radiation A propagating through the arms of the interferometer, and the Y-axis shows the transmission T. Modification of the optical characteristics of a telecommunication device based on a resonator in the form of a microring and an external interferometer may be achieved through thermal tuning or injection tuning on the arms of the interferometer. This may cause the transmission to be adjusted with a simultaneous shift in the position of the resonance. As shown in FIG. 1C, this may cause inter-channel interference in the telecommunication device, which may cause a change in the transmission intensity in neighboring spectral channels.

FIG. 1D shows tuning curves of a microring resonator of the related embodiment.

Referring to FIG. 1D, the resonance center wavelength shift curve Δ (the curve as a dotted line—corresponding to values on the Y-axis on the left) and the extinction ratio ET change curve (the curve as a dotted line and crosses—corresponding to values on the Y-axis on the right) are a function of a voltage V_{ICPH} applied to a heater in an outer loop (in-coupler photoconductive heater—(ICPH)) of the microring resonator. In this regard, the microring resonator is based on the configuration of the interferometer with upper and lower interferometric arms, of the related embodiment.

As shown in FIG. 1D, the radiation at a resonant wavelength may be modified, by applying voltage to the outer (ICPH) loop of the microring resonator based on the configuration of the interferometer with the upper and lower interferometric arms, and thus the shift of the resonant wavelength or the extinction ratio of the resonance may be changed.

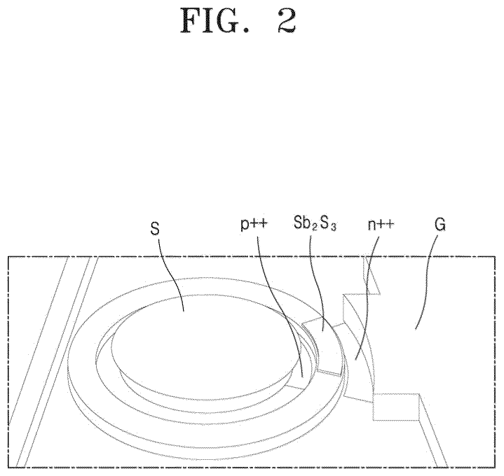

FIG. 2 is a top view of a microring resonator of the related embodiment.

Referring to FIG. 2, with a portion covered with a layer of Sb₂S₃, an external voltage is applied to the resonator by metal contacts, which are designated as S (signal) and G (ground), on p++ and n++ regions—regions of high doping of silicon of different conductivity types (holes and electrons). Due to local heating of the resonator portions when an electric current flows through the device, a phase state of the Sb₂S₃ material layer is rearranged, which leads to a change in the refractive index of a material, and, as a result, to a shift in resonance. This may lead to a modification of the optical properties of the optical filtering device. However, inter-channel interference may occur in neighboring channels.

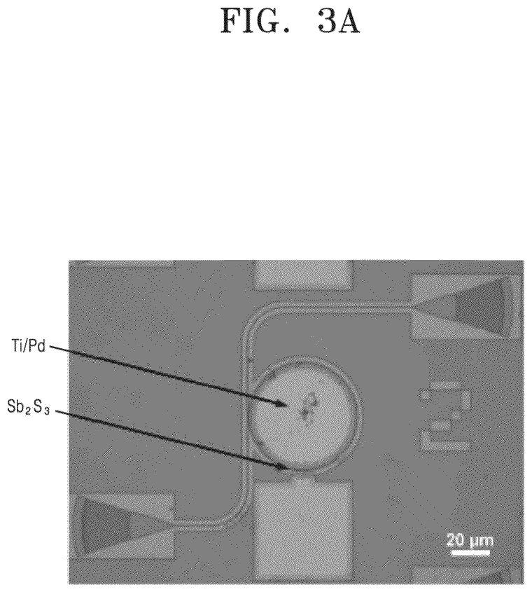

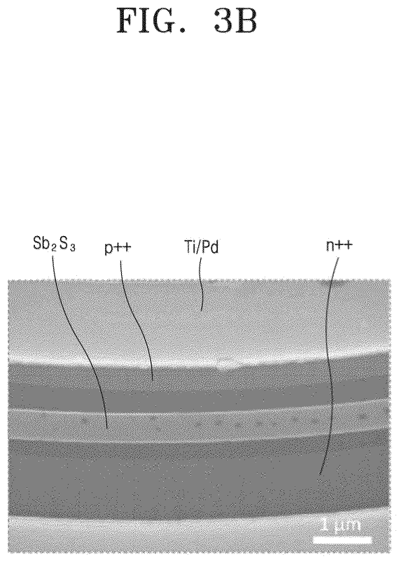

FIG. 3A is a top view of a microring resonator with waveguides of the related embodiment.

A layer of antimony sulfide (Sb₂S₃) and metal contacts may be deposited on a portion of the microring resonator. An external voltage is applied to the resonator by metal contacts made of a palladium-titanium alloy (Ti/Pd), on regions with a relatively high carrier concentration: p++ and n++—regions (of high doping of silicon with holes and electrons). Due to local heating of the resonator portions when an electric current flows through the device, a phase state of the Sb₂S₃ material layer is rearranged, which may lead to a change in the refractive index of a material, and, as a result, to a shift in resonance. This may lead to a modification of the optical properties of the optical filtering device, but inter-channel interference may occur in adjacent channels.

The waveguides may be equipped with grating couplers (GC).

FIG. 3B shows a magnified microscope image of a real structure from the portion of the microring resonator shown in FIG. 3A. Referring to FIG. 3B, Ti/Pd layers, p++ and n++ doped regions, and a Sb₂S₃ layer may be shown.

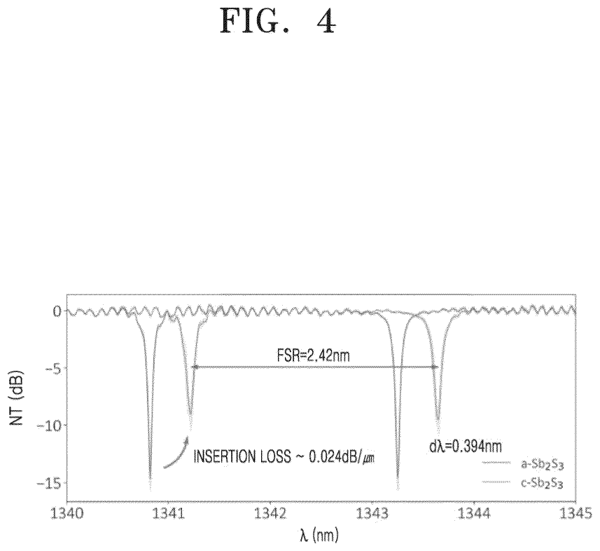

FIG. 4 shows a resonance profile of a microring resonator of the related embodiment.

Referring to FIG. 4, with a change in a phase state of a Sb₂S₃ material, the X-axis represents the wavelength λ, and the Y-axis represents a normalized transmission NT normalized to a reference waveguide. A normalization process may allow to remove hardware functions of the optical filtering device, such as transfer functions of the input-output gratings (GC). The spectrum of a waveguide without a resonator, but with similar input-output gratings, is recorded, and then the spectrum may be used for normalization.

A thin film of phase change material (PCM), in this case a film made of Sb₂S₃ material, may be deposited on the microring resonator portion. The properties of the PCM may be used to adjust the phase velocity of propagation of an optical signal in a circuit of the microring resonator. In an amorphous state, the material has one spectral response, which may be shown in the curve in the form of crosses in FIG. 4. In a crystalline state, a completely different spectral response, a solid curve, may be shown. At the same time, after switching from the amorphous state to the crystalline state (and vice versa), the PCM layer may retain the same state and not require additional energy to maintain the same state. As shown in FIG. 4, a free spectral range (FSR) is 2.42 nm, an insertion loss is 0.024 dB/μm, and a resonance shift dλ is 0.394 nm. The insertion loss shows a decrease in the extinction ratio for the resonance the depth of a dip) when the phase state of the material on the microring resonator is switched. Because in the crystalline state, the Sb₂S₃ material absorbs more radiation than in the amorphous state, this effect may appear. The change in the phase velocity is associated with a change in the real part of the refractive index of the material, and the change in extinction ratio is associated with a change in the imaginary part of the refractive index (i.e., the absorption described above). The FSR in FIG. 4 shows a distance between two adjacent resonance lines for a particular device which correspond to two adjacent azimuthal modes of the microring resonator, and is determined by its radius and the effective refractive index for the optical mode propagating in the resonator.

Thus, the configuration of the microring resonator based on the PCM may provide energy independence of the device. Accordingly, no additional external influence on the resonator is required to maintain a given state, but this causes disadvantage of being accompanied by crosstalk due to the spectral shift of the resonance.

A related embodiment may be directed to a reconfigurable photonic device used for filtering and an intensity modulation method in a photonic computing system based on interferometric coupling. The photonic device includes a first waveguide and a second waveguide, and a tunable microring resonator (MRR) arranged therebetween, and is implemented in the form of a waveguide loop. The first and second waveguides are optically coupled through the resonator ring. Each of the first and second waveguides may form symmetrical interferometric arms (Mach-Zehnder interferometers (MZI)). This photonic device may regulate the modulation of the optical signal by using control elements based on the principles of thermomodulation. In the photonic device, the transmission of optical signals may be modulated using tunable waveguide elements (MRR, MZI), which may use a change in the phase velocity of the light wave in the waveguide due to the thermo-optical change in the refractive index of a waveguide material. The thermo-optical change in the refractive index of the waveguide material may be achieve by a metal heater located in a portion of one of the waveguides or the addition of a PN-junction by adjusting a carrier density. In the above-described device, the amount of transmission of the optical signal through the waveguides at several wavelengths may be changed without shifting the resonance, leading to inter-channel interference. However, in the above-described device, constant significant energy consumption is required to maintain the required optical characteristics of the device. When the external thermal effect on the portions of the waveguide ends, the optical characteristics of the device return to their original state.

The related embodiment is directed to a photonic hardware accelerator of a convolutional neural network based on a microring resonator and a non-volatile phase change material. The microring resonator may include a ring resonator and waveguides. In this case, a PCM may be deposited on a portion of the microring resonator. The PCM may be a germanium-antimony-tellurium (GeSbTe) material. The properties of the PCM may be used to adjust the speed of propagation of the optical signal in a waveguide loop, by changing the spectral response of signals according to the current state of the PCM. In the amorphous state, the material may have one spectral response, and in the crystalline state, may have a completely different response. The PCM has two stable states (amorphous/crystalline) so that the amount of transmission of the optical signal may be controlled in the waveguide by changing the state of the material to crystalline or amorphous. However, the PCM may lead to significant absorption of the optical signal inside the waveguide, which may cause a resonant spectral shift when tuning a modulator. Thus, inter-channel crosstalk may occur, and performance in a dense wavelength division multiplexing (DWDM) system may be reduced.

Thus, in order to eliminate all the above-mentioned drawbacks of optical devices of the related embodiment intended for radiation filtering, according to one or more embodiments, an optical filtering device and a method of tuning the optical filtering device capable of implementing relatively low inter-channel interference and low power consumption for performing spectral tuning of the device during its repeated use may be provided. The optical filtering device according to one or more embodiments is implemented to provide independent control of the resonance in the interferometric arms of the waveguide and the microring resonator, thereby making it possible to change the amplitude of the signal without shifting a resonance line in the spectrum of the optical filtering device.

Microring resonator may be a waveguide in the form of a ring, which may have a radius of curvature that determines resonant wavelengths of the resonator (the so-called azimuthal modes). For example, the microring resonator may have the radius of curvature from several micrometers to tens of micrometers.

Interferometric arm may be a portion of a waveguide that is optically coupled to a microring resonator in two regions to introduce an additional delay line into the passing radiation. Interference between radiation in the microring resonator and the interferometric arm may allow you to control both the depth of the optical resonance of the filter and its spectral position.

Mach-Zehnder interferometer may be an interferometer including an input beam splitter (either a direct waveguide coupler or a Y-splitter), two interferometric arms in the form of straight or curved waveguides, and an output beam splitter. For example, a part of the microring resonator between regions of optical contact between the microring resonator and the interferometric arm acts as one of the arms, while the light between the arms is divided in the region of optical coupling.

A local thermoheater (hereinafter referred to as local PIN microheater) may include an external voltage source, electrical contacts and corresponding doping regions in a silicon layer.

Waveguide may be rib waveguides (single-mode ridge waveguides) or strip waveguides. In cross section, single-mode ridge waveguides or strip waveguides are solid plates of silicon or other material with a relatively high refractive index, on which a region of rectangular cross section may be etched, and in the center of which optical radiation may propagate.

A coupled mode and a waveguide mode may be herein used as synonymous. The waveguide mode may be a configuration of an electromagnetic field (electromagnetic oscillations) in a waveguide, which is an eigen solution of Maxwell's equations for a given geometry. In the waveguide mode, light may propagate in the waveguide with almost no loss (there may be many such modes, but most often they operate in a single-mode region). Most of the electromagnetic energy of the waveguide mode is concentrated in the center of the waveguide (in the core), hence named as the coupled mode.

A selected wavelength (predetermined wavelength) may be a wavelength of optical radiation corresponding to the excitation of resonance in the optical filtering device may be considered.

A resonant wavelength may be a position of the dip in the transmission spectrum of the filter, which may be the excitation of one of the azimuthal modes in the microring resonator.

The phase of radiation is a characteristic of an electromagnetic wave (along with amplitude), which may determine how the field of this wave oscillates at each point in space as the wave propagates.

A substrate may be a silicon substrate but embodiments are not limited thereto, and may include another material.

A chip may include a microcircuit (a device, contacts to the device, and a substrate on which the device and contacts to the device are located).

Herein, of the substrate and the chip may be interchangeable.

The working layer of silicon may be a top layer of silicon in a silicon-on-insulator (SOI) structure, may have a thickness of several hundred nanometers, and from which an integrated optical device may be formed by reactive ion etching through a resistive mask.

The non-volatile, reconfigurable, optical filtering device according to one or more embodiments may be a multi-resonant filter with PCM sections for tuning the optical characteristics of the device.

The non-volatile, reconfigurable optical filtering device according to one or more embodiments may provide spectral response tuning. The optical filtering device according to one or more embodiments may include a microring resonator (MRR) and at least two interferometric arms (MZI) (e.g., a Mach-Zehnder interferometer). PCM sections of a PCM deposited may be located on predetermined portions of the MRR and the at least two MZIs.

The optical filtering device according to one or more embodiments may provide relatively low inter-channel interference and low power consumption for spectral tuning during repeated use of the optical filtering device.

The optical filtering device according to one or more embodiments may provide multiple independent PCM sections for controlling the amplitude and position of the resonance.

The optical filtering device according to one or more embodiments may independently control the resonance in the interferometric arms of the Mach-Zehnder interferometer configuration through multiple PCM sections, thereby changing the amplitude of the signal without shifting the spectral lines in the optical filtering device.

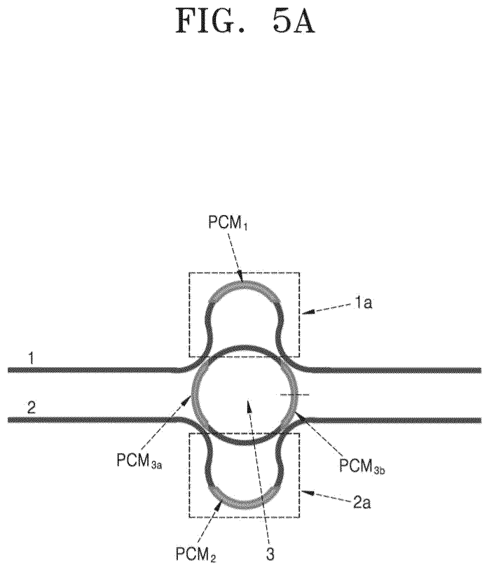

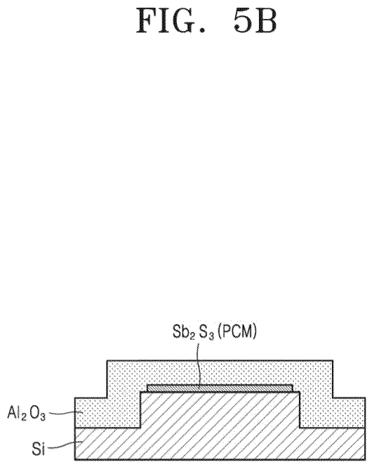

FIG. 5A is a schematic top view of an optical filtering device according to one or more embodiments.

Referring to FIG. 5A, the optical filtering device according to one or more embodiments may include a first waveguide 1, a second waveguide 2, and a microring resonator 3 having two sections covered with a layer of sections PCM₃ₐ and PCM_{3b}, and located between the first waveguide 1 and the second waveguide 2.

For example, opposite portions (segments) 1a and 2a of waveguides located in a region in which the microring resonator 3 is located may repeat the shape of a ring resonator, and form the first interferometric arm 1a and the second interferometric arm 2a based on a configuration of a Mach-Zehnder interferometer. The bending radii of the first interferometric arm 1a and the second interferometric arm 2a in the region in which the microring resonator 3 is located may be selected taking into account the compactness of the optical filtering device and minimizing radiation losses during the passage of radiation through the first interferometric arm 1a and the second interferometric arm 2a. For example, the optical filtering device may be formed that the phases of radiation in the first interferometric arm 1a and the second interferometric arm 2a and in the microring resonator 3 must be matched. For example, the phase of radiation at the required resonant wavelength that has passed through the first interferometric arm 1a may coincide with a multiple of 2πn (where n is an integer) with the phase of radiation that has passed through the microring resonator 3 between the points of optical coupling (hereinafter, as regions of optical coupling) with the first interferometric arm 1a.

In addition, the first interferometric arm 1a and the second interferometric arm 2a may have PCM sections (designated as PCM₁ and PCM₂, respectively). Each of the first interferometric arm 1a and the second interferometric arm 2a may be located to have at least two regions located in relatively close proximity to the microring resonator 3, to provide optical coupling between the first interferometric arm 1a and the second interferometric arm 2a and the microring resonator 3 due to the near electromagnetic field of the passing wave.

FIG. 5B is a cross-sectional view of a microring resonator in PCM sections according to one or more embodiments.

The first waveguide 1 and the second waveguide 2 are single-mode ridge waveguides or strip waveguides including silicon or silicon nitride or any materials used for the production of waveguides (FIG. 5B shows a silicon substrate with a SiO₂ layer).

The portions of the waveguides forming the first interferometric arm 1a and the second interferometric arm 2a have the sections PCM₁ and PCM₂, respectively. The sections PCM₁ and PCM₂ may be layers of PCM including the group of chalcogenide glasses from the GSST family or other phase change materials. For example, FIG. 5B shows an example of a PCM section of the microring resonator 3 including a Sb₂S₃ material. However, embodiments are not limited thereto, and the PCM section of the microring resonator 3 may include other materials, such as Sb₂Se₃. A protective (passivating) layer including Al₂O₃ may be located above and/or on the first interferometric arm 1a and the second interferometric arm 2a and the microring resonator 3 in the region of the PCM sections. The protective (passivating) layer may perform a protective function for the sections PCM₁ and PCM₂ of the first interferometric arm 1a and the second interferometric arm 2a and sections PCM₃ₐ and PCM_{3b} of the microring resonator 3.

The optical filtering device according to one or more embodiments may be integrated into any optoelectronic device based on electro-photonic integrated circuits (EPIC), etc., or may function autonomously as an independent device. Thus, an external radiation source used to pump into the waveguide circuit may be provided from the outside, and continuous or pulsed radiation sources may be used. For example, the external radiation source may generate an initial radiation source, a continuous radiation source, a coherent radiation source, and an electromagnetic radiation source with a wavelength in the optical range. For example, the external radiation source may be a pulsed laser. In this case, radiation may be introduced both into the first interferometric arm 1a and the second interferometric arm 2a by delivering radiation to a chip or substrate, for example, by fiber pigtailing, input-output diffraction grating, etc.

In the optical filtering device according to one or more embodiments, detectors for measuring the optical signal at the input or output of the waveguide loop may be located. The detectors may be located outside the optical filtering device. However, embodiments are not limited thereto, and the detectors may be located on the same chip as the optical filtering device, or may be separate from each other. For example, the detectors may be produced based on silicon-germanium and based on other materials from alloys of group 3-5 compounds. Because several optoelectronic devices connected in series may be placed on the same chip together with the optical filtering device, the inputs and outputs of the first interferometric arm 1a and the second interferometric arm 2a are not necessarily directly connected to the radiation source and the detector, and may be directly connected to other devices.

According to one or more embodiments, the optical filtering device needs to be tuned before data transmission begins. For the operation of the optical filtering device, the radiation that passes through the structure provided in the optical filter device does not exceed the power threshold at which its irreversible destruction may occur.

According to one or more embodiments, the optical filtering device including a waveguide loop (the first waveguide 1 and the second waveguide 2), the first interferometric arm 1a and the second interferometric arm 2a, and the microring resonator 3 may include sections with a layer of PCM (hereinafter, as PCM sections), making it possible to independently adjust or regulate the spectral response in each of the first interferometric arm 1a and the second interferometric arm 2a, and the microring resonator 3. Independently adjusting or regulating the spectral response in each of the first interferometric arm 1a and the second interferometric arm 2a, and the microring resonator 3 may be determined according to the specified transmission requirements in each of these portions.

The speed of propagation of the optical signal in the waveguide loop may be adjusted through the properties of the PCM material, by changing the spectral response of the signals according to the current state of the PCM material. In the amorphous state, the PCM may have one spectral response, and in the crystalline state, the PCM may have a different spectral response. The PCM may have two stable states (amorphous/crystalline), and control the phase and, as a result, the resonance conditions for the optical signal in the waveguide by changing the state of the PCM to crystalline or amorphous.

In the optical filtering device according to one or more embodiments, the portions of the waveguides near the location of the PCM sections are connected by electrical contacts for local heating and crystallization/amorphization of the PCM sections on the interferometric arms and in the microring resonator and perform resonance control through local heating and crystallization/amorphization of the PCM sections. In the related embodiment, continuous thermal tuning of the waveguide sections was used to control the optical filter device, in the optical filter device including the microring resonator based on interferometry.

To implement the phase transition process on at least one portion of the PCM section, the following steps may be performed.

The initial state of the phase change material in the optical filtering device is amorphous, and the amorphous state is achieved by a relatively short and intense electrical pulse with a voltage in the range from about 1 V to about 10 V and a duration of the order of 500 ns through electrical contacts. The above-described electrical pulse is referred as a reset pulse, by which the portion of the PCM section may be completely transferred to the amorphous state. Thus, when an electrical pulse with a voltage of 10 V is applied to the portion of the waveguide with the PCM section, the PCM section may be relatively rapidly heated above the melting point, followed by relatively rapid cooling and solidification of the PCM section in the amorphous state.

Then, by applying sequentially electrical pulses (set pulses) in the range from about 1 V to about 10 V with durations of about 100 μs and a duty cycle of up to 1 second between pulses, the phase state of the PCM portion may be gradually restructured (the presented voltage values are given as an example, and the above voltage values applied to the PIN heater near the PCM section may be differently determined according to many factors, e.g., the type of PCM, device geometry, and other parameters). The PCM section may be heated above the glass transition temperature but below the melting point, which may cause the process of partial crystallization of the PCM section.

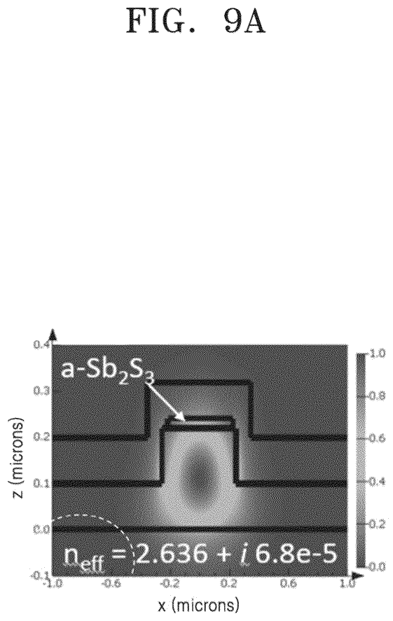

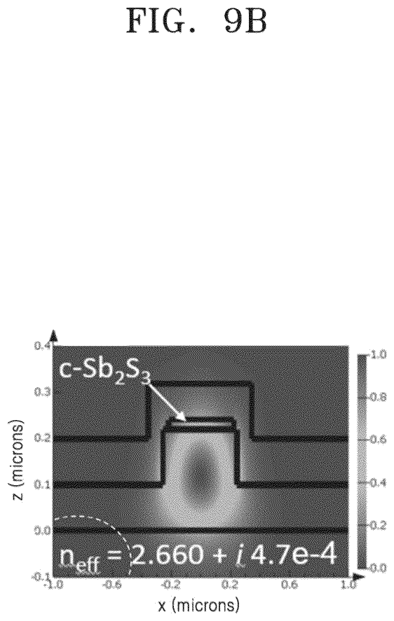

The effective refractive index of the PCM section in the crystalline state and the amorphous state may be different, and thus the above process may cause a gradual change in the optical response by introducing a phase shift into the optical signal. FIGS. 9A and 9B illustrate effective refractive indices for a propagating waveguide mode in crystalline and amorphous states of the PCM section. Referring to FIGS. 9A and 9B, the effective refractive index of the mode propagating in the core of a waveguide may be adjusted by partially switching the PCM section from the amorphous (FIG. 9A) to the crystalline (FIG. 9B) state (and vice versa). The effective refractive index of the mode in the waveguide in the crystalline and amorphous states of the PCM differs by about 1%, which may cause a shift in the resonance of the optical filter device. In the amorphous state, the real part of the effective refractive index is n_{eff}=2.636 (see FIG. 9A), and in the crystalline state, n_{eff}=2.660 (see FIG. 9B). For example, the additional phase incursion that is obtained in one PCM section may be calculated during a complete switching from the crystalline state to the amorphous state. The difference in effective refractive indices for the waveguide mode in the crystalline and amorphous states of PCM is 0.024, considering a section with a length of, for example, 5 μm, the additional phase incursion may be approximately 0.16.

After tuning, the state of the PCM section is fixed and may be maintained without additional power consumption. Thus, the energy efficiency of the optical filtering device according to one or more embodiments may be improved. The optical filtering device may be provided with the possibility of its reuse.

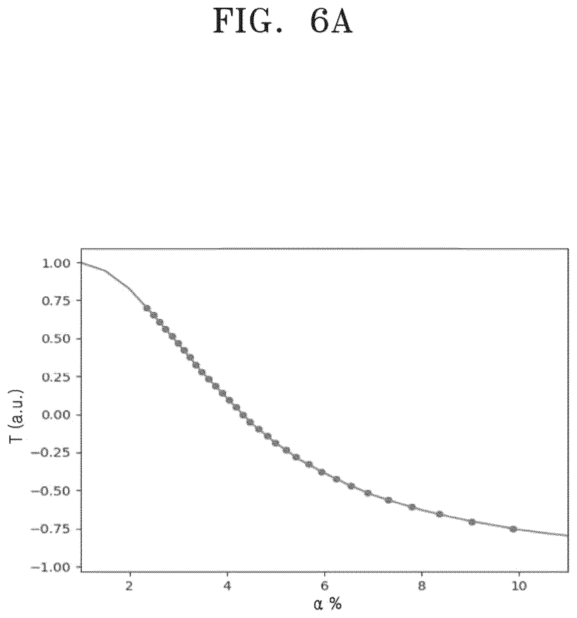

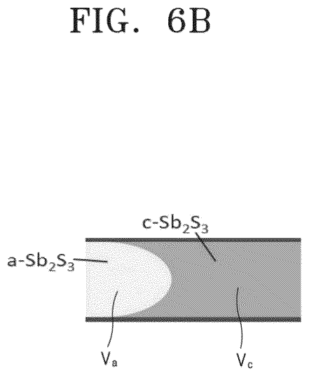

FIG. 6A is a graph illustrating the signal transmission in an optical filtering device when using a Sb₂S₃ material in the PCM section, according to the phase state (amorphous or crystalline) of the PCM according to one or more embodiments.

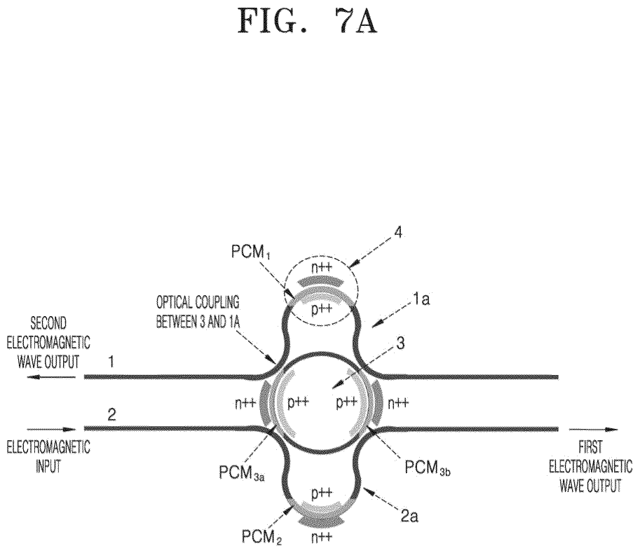

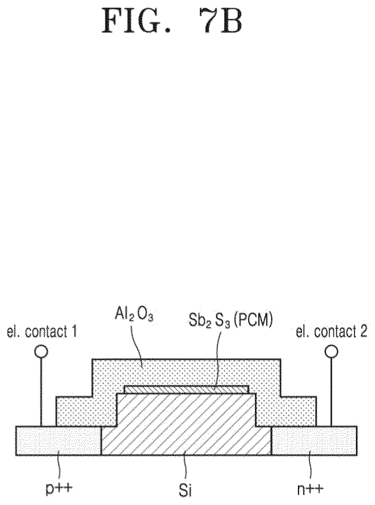

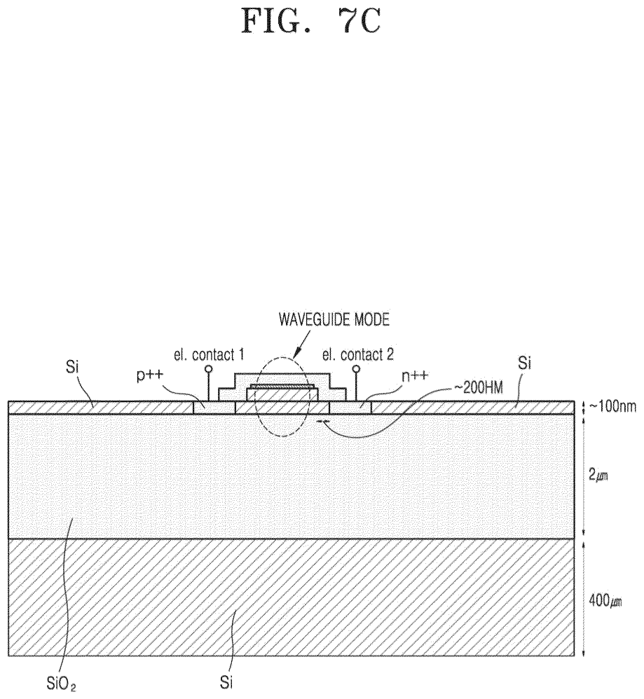

Referring to FIG. 6A, the X-axis shows a coefficient (a %), which shows the proportion of crystalline and amorphous phases in the PCM section (volume ratio), the Y-axis shows T (transmission) of the signal on a photodetector (arbitrary units (a.u.)) according to the phase state of the PCM. In this case, the photodetector includes two detectors, one of which is located at the output of the second waveguide 2 (see FIG. 7A, “radiation output” on the right), and the second one is located at the input of the waveguide 1 (see FIG. 7A, “radiation output” on the left), The detected signal is the result of subtracting the signals from the two detectors.

FIG. 6B schematically illustrates amorphous (a-Sb₂S₃) and crystalline (c-Sb₂S₃) states of the PCM section of the material, after thermal exposure to the PCM section according to one or more embodiments.

Here, the coefficient α of the PCM section of the material satisfies [Equation 1] below.

$$α = va / ( va + vc ) \qquad [ Equation 1 ]$$

Here, vₐ is the volume of the amorphous phase, and v_{c} is the volume of the crystalline phase.

As shown in FIG. 6A, the gradual crystallization of the PCM may change the transmission of radiation by the optical filtering device at a selected wavelength, while simultaneously reducing the power consumption of the optical filtering device. This is because each of the PCM sections during the tuning process of the optical filtering device according to one or more embodiments does not require additional thermal or injection tuning during the operation of the optical filtering device.

According to one or more embodiments, at least 3 PCM sections may be located in the optical filtering device to control the amplitude of the resonance and the position of the resonance. Referring to FIG. 5A, four PCM sections are shown, but the number of PCM sections is not limited thereto, and may include three or more PCM sections, according to the tasks and conditions for using a reconfigurable optical filtering device.

According to one or more embodiments, opposite pairs of PCM sections PCM₁, PCM₂, PCM₃ₐ, and PCM_{3b} may be provided in the configuration of the optical filtering device based on the microring resonator (see FIG. 5A). However, the resonator configuration with opposing PCM sections is optional and may be different. However, the PCM sections must be positioned to ensure their thermal isolation from each other when switching the phase state of each section to eliminate interference due to thermal effects on at least one of the PCM sections.

The combination, for example, of 3 or 4 independent PCM sections, each of which may be reconfigured individually without affecting other PCM sections in opposite parts of the microring resonator 3 and opposite interferometric arms (MZI) of the optical filtering device may enable control the amplitude of the resonance without spectral shifts.

Separate adjustment of the inner portions of the microring resonator (MRR) (in this case, inner portions PCM₃ₐ and PCM_{3b}), causes predominantly a spectral shift of the resonance spectrum, while adjusting the outer portions (sections PCM₁ and PCM₂) of the first interferometric arm 1a and the second interferometric arm 2a (see FIG. 5A) may cause both a resonance shift and a change in its amplitude.

In the optical filtering device according to one or more embodiments, PCM sections related to the microring resonator 3 (MRR) and in the first interferometric arm 1a and the second interferometric arm 2a (MZI) may be preliminarily tuned or differently configured. For example, the PCM₃ₐ section of the microring resonator 3 may be tuned using a Sb₂S₃ compound as a PCM. The property of PCM may adjust the phase velocity of propagation of the optical signal in the loop of the microring resonator 3. In the amorphous state, the PCM may have one spectral response, and in the crystalline state, the PCM may have a completely different spectral response.

To change the phase state of the PCM, the PCM section is subjected to thermal action by using a local PIN heater, and thus changing its phase state in the section PCM₃ₐ. The PIN heater may include an external voltage source located at a distance from the microring resonator (MRR) and the interferometric arm (MZI), electrical contacts and doped regions: electrons and holes (p++ and n++), and be located in relatively close proximity to the section PCM₃ₐ to be tuned. Thus, when applying several voltage pulses in the range from about 1 V to about 10 V, for example, by using an electric probe connected to a voltage source, amorphization with durations of about 500 ns and crystallization with durations of about 100 μs may be performed, and a duty cycle of up to 1 second between pulses may be set. In this case, the electrical contacts that are in contact with the doped regions (p++ and n++) are achieved by using the electric probe connected to the voltage source. The section PCM₃ₐ corresponding to the electrical contact region spaced from the microring resonator 3 with the section PCM₃ₐ at a distance of approximately 200 nm is heated, to avoid optical losses, which may cause the process of partial crystallization of the section PCM₃ₐ. The crystallization process, for example, the phase switching process from the amorphous state to the crystalline state is described with reference to FIG. 6B.

In the crystalline state, the Sb₂S₃ material may absorb slightly more radiation than in the amorphous state (see FIG. 4), which may cause induced losses. In this case, the change in the refractive index of the material of the section PCM₃ₐ between the amorphous and crystalline states may be accompanied by a change in the phase velocity of propagation of the optical signal in the microring resonator 3 (see FIG. 6A, which shows the dependence of the transmission (T) of the optical signal through the optical filtering device on the coefficient α, which shows the proportion of crystalline and amorphous phases in the PCM section). Gradual crystallization of the section PCM₃ₐ on the microring resonator 3 leads to a gradual increase in the effective refractive index for optical radiation propagating in the section PCM₃ₐ, which may affect the phase velocity of the wave, which may lead to the appearance of an additional phase incursion. Thus, the resonant properties of the microring resonator 3 may change (the effective optical path changes). This may lead to a spectral shift of the resonance as shown in FIG. 4.

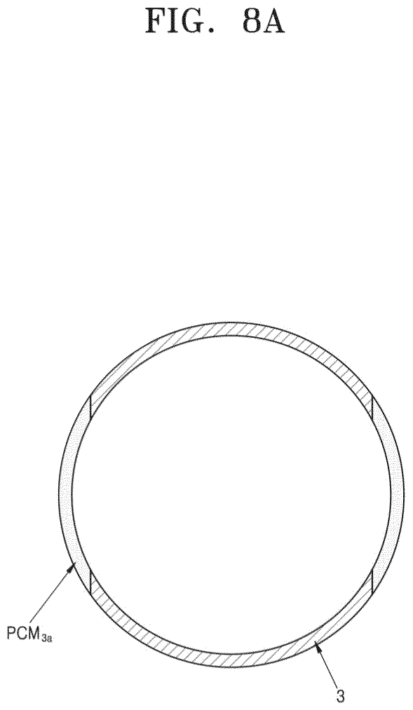

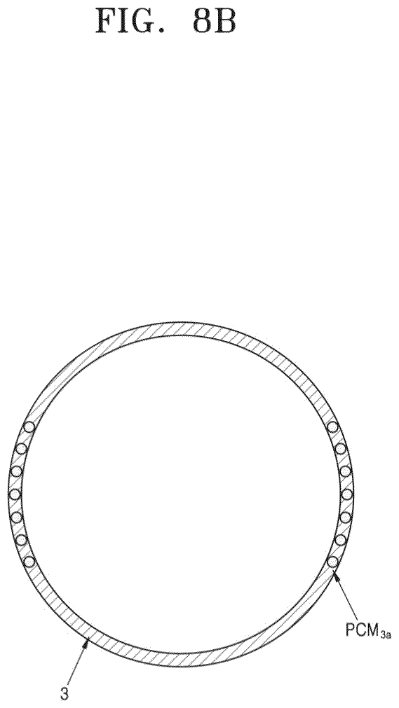

A tuning process on the section PCM_{3b} may be implemented by repeating the tuning processes occurring in the section PCM₃ₐ achieved by the conditions and parameters (the amplitude of the electrical signal, the pulse duration, etc.) The main task of the section PCM_{3b} tuning is to ensure a given refractive index for radiation in the PCM section, which is currently being affected, and the given refractive index may determine the subsequent processes described in the waveguide. The sections PCM₃ₐ and PCM_{3b} may be thermally tuned at different times or simultaneously using a local PIN heater. The phase switching may be applied to both the entire PCM section and pre-selected portions, in the form of circles, ellipses, etc., as shown in FIG. 8B.

Next, the tuning processes of the sections PCM₁ and PCM₂ occurring in the first interferometric arm 1a and the second interferometric arm 2a, respectively, are described. For example, the tuning process is described using the example of the section PCM₁, while the Sb₂S₃ compound is used as a PCM. The property of PCM may enable to adjust the phase velocity of propagation of the optical signal in the loop of the first waveguide 1, in the amorphous state, the PCM has one spectral response, and in the crystalline state, the PCM has a completely different spectral response (see FIG. 4). To change the phase state of the PCM, the PCM section, e.g., the section PCM₁, is subjected to thermal action by using a local PIN heater. The PIN heater may include an external voltage source located at a distance from the microring resonator (MRR) and the interferometric arm (MZI), electrical contacts and corresponding doped regions in the working silicon layer. For example, doped regions (boron ions are usually used to create p++ regions in the working silicon layer, and phosphorus ions for n++): electrons and holes (p++ and n++) may be located on both sides in close proximity to the section PCM₁ to be tuned.

Thus, several voltage pulses with an amplitude in the range of about 1V to about 10V are applied with different durations of about 500 ns for amorphization and about 100 μs for crystallization, and a spacing of up to 1 second between pulses. By an electrical probe connected to a voltage source, voltage pulses are applied between the corresponding electrical contacts that are in contact with the doped regions (p++ and n++). The section PCM₁ corresponding to the electrical contacts spaced from the first waveguide 1 with the PCM₁ section by a distance of approximately 200 nm is heated, to avoid optical losses, which may cause the process of partial crystallization of the section PCM₁. The crystallization process, for example, the phase switching process from the amorphous state to the crystalline state is described with reference to FIG. 6B.

In the crystalline state the Sb₂S₃ material absorbs more radiation than in the amorphous state (see FIG. 4), which may cause induced losses. In this case, the change in the refractive index of the material of the section PCM₁ between the amorphous and crystalline states may be accompanied by a change in the phase velocity of propagation of the optical signal in the first interferometric arm 1a (see FIG. 6A, which shows the dependence of the transmission T of the optical signal through the optical filtering device on the coefficient α, showing the proportion of the crystalline and amorphous phases in the PCM section). Gradual crystallization of the section PCM₁ on the first interferometric arm 1a may lead to a gradual increase in the effective refractive index for optical radiation propagating the section PCM₁. The gradual increase in the effective refractive index may affect the phase velocity of the wave, which also changes the optical properties of the first waveguide 1 (the effective optical path changes). In this case, the radiation propagating in the first interferometric arm 1a may interfere with the radiation propagating in the microring resonator 3 due to the optical coupling in the regions of their proximity. The interference conditions may depend on the phase shift between the waves in the MZI and the microring resonator 3, which may be controlled by the state of all the PCM sections described above. This may lead to a spectral shift of the resonance and a change in its amplitude. In this case, the phase shift in the first interferometric arm 1a and the second interferometric arm 2a of the first waveguide 1 and the second waveguide 2, respectively, may be selected to compensate for the resonance shift due to modulation in the microring resonator 3 Thus, the spectral position of the resonance of the optical filtering device does not change, but only its depth (amplitude) may change. The phase switching may be applied to both the entire PCM section and pre-selected portions, in the form of circles, ellipses, etc., as shown in FIG. 8B.

A tuning process on the section PCM₂ may repeat the tuning processes occurring in the section PCM₁ achieved by the conditions and parameters (the amplitude of the electrical signal, the pulse duration, etc.) In this case, the main task of tuning the sections PCM₁ and PCM₂ is to ensure a given refractive index for the radiation propagating in the PCM section currently being exposed. Thus, the subsequent processes may be determined in the waveguide. The sections PCM₁ and PCM₂ may be tuned at different times or simultaneously using a local PIN heater. Before operation, the optical filtering device according to one or more embodiments may be calibrated according to the following steps.

For each PCM section to be subsequently tuned, a preliminary dependence of its degree of crystallization on the parameters (pulse amplitude, its duration, repetition rate, number of pulses) of the electrical pulses applied to the corresponding local PIN heater may be read. A set of metastable states is obtained, each of which may be further used during tuning.

Next, the required level of transmission of the optical filtering device is selected for the selected wavelength at which the corresponding portion of the waveguide with the PCM section operates. The degree of crystallization of each PCM portion is numerically estimated to implement the required transmission function.

According to the obtained estimate, the closest metastable state of the PCM sections may be selected by using the multiparameter dependence obtained in step 1. Thereafter, each of the PCM portions may be sequentially tuned to the desired metastable level by applying electrical pulses of the selected duration, amplitude and repetition rate.

After completing the procedure for all PCM portions, the optical filtering device may be used for optical filtering without additional external manipulation and setup.

At the same time, other methods may be used for preliminary calibration (e.g., the method of successive approximations with feedback) For example, a sequential tuning process due to the temperature modulation of the optical properties of waveguides and an algorithm for sequential tuning in MRR and MZI may be performed. The method is not necessary to pre-build a map of the dependence of the degree of crystallization on various parameters of the pulsed effect on the heater.

The preliminary setup and subsequent operation of an optical filtering device according to one or more embodiments are described with reference to FIGS. 7A and 7B.

FIG. 7A schematically shows a top view of an optical filtering device according to one or more embodiments. FIG. 7B shows a cross-section of the PCM section and adjacent portions according to one or more embodiments.

FIGS. 7A and 7B show both portions of the first interferometric arm 1a and the second interferometric arm 2a with sections PCM₁ and PCM₂ and portions of the microring resonator 3 with sections PCM₃ₐ and PCM_{3b} according to one or more embodiments. The only difference lies in the location of the doped regions (n++, p++). The locations of the doped regions relative to the corresponding PCM section are shown in FIG. 7A.

Part of the structural elements is omitted in the drawing to avoid overloading the drawing, but is described in detail.

The process of preliminary calibration and individual tuning of the optical filtering device according to one or more embodiments has been described in detail above, and the optical filtering device may operate in a pre-reconfigured form, i.e., with individually tuned sections PCM₁ and PCM₂ of the first interferometric arm 1a and the second interferometric arm 2a, and with tuned sections PCM₃ₐ and PCM_{3b} of the microring resonator 3.

As shown in FIG. 7A, one local PIN microheater 4 may be located in the region of the section PCM₁ on the first interferometric arm 1a. However, similar local PIN microheaters may be located, each in the region of the corresponding PCM section. Each of the local PIN microheaters 4 may include an external voltage source and a pair of electrical contacts located on either side of the corresponding PCM section. In this case, the external voltage source is located at a distance from the configuration of the interferometric arms and the microring resonator (MRR+MZI), which may prevent the induction of additional optical losses.

FIG. 7B shows a cross-section of the PCM section region and adjacent regions. Here, an upper silicon working layer Si may include doped regions of p++ and n++ type (boron ions are usually used to create p++ regions in silicon, and phosphorus ions are used for n++). The doped regions are spaced from the first waveguide 1 and the second waveguide 2 and the microring resonator 3 with PCM sections at a distance of approximately 200 nm to avoid optical losses. A pair of electrical contacts (el.contact 1 and el.contact 2 in FIG. 7B) of each local PIN microheater 4 may contact the doped regions and when voltage is applied from the corresponding voltage source, the corresponding PCM section may be heated (Sb₂S₃(PCM) in FIG. 7B). Thus, the process of partial crystallization of the PCM section may occur.

A protective layer of Al₂O₃ compound may be provided over each PCM section and the adjacent regions of the silicon working layer (Al₂O₃ in FIG. 7B). The protective layer may serve to protect the PCM section from external influences, as well as reforming (spreading and subsequent degradation) of the PCM section during thermal restructuring.

FIG. 7C shows a structure of a substrate according to one or more embodiments.

Referring to FIG. 7C, the substrate may be located on the optical filtering device according to one or more embodiments. The substrate may include a base layer of silicon (Si), a layer of silicon oxide (SiO₂) may be disposed on the base layer of silicon (Si), and a working layer of silicon (Si) may be disposed on the base layer of silicon (Si). The base layer of silicon may integrate the optical filtering device thereinto, and the working layer of silicon may be structured in line with the configuration of the optical filtering device. The doped regions p++ and n++ may be located in the silicon working layer on the sides of the waveguide at a distance of about 200 nm.

For example, the base layer of silicon may be 400 μm, the layer of silicon oxide may be 2 μm, and the remaining (underetched) part of the silicon working layer may be 100 nm. However, embodiments are not limited thereto, and thickness, material and structure of the substrate may be differently determined.

The optical filtering device according to one or more embodiments may operate at wavelengths of the telecommunication range, including a C-band and an O-band (1260 nm to 1675 nm). The optical filtering device may operate with both continuous and pulsed radiation. At the same time, the power of the radiation supplied to the circuit of the optical filtering device does not exceed the destruction thresholds for the optical filtering device.

Referring back to FIG. 7A, the optical filtering device according to one or more embodiments may include the first waveguide 1, the second waveguide 2, and the microring resonator 3 located on a silicon substrate (chip) including a dielectric layer of SiO₂. The microring resonator 3 may have at least two sections covered with a layer of phase change material (hereinafter referred to as sections PCM₃ₐ and PCM_{3b}) and be located between the first waveguide 1 and the second waveguide 2.

For example, the opposite portions (segments) 1a and 2a of the first waveguide 1 and the second waveguide 2, respectively, located in the region of the microring resonator 3, may be formed to form the first interferometric arm 1a and the second interferometric arm 2a based on the Mach-Zehnder interferometer configuration. The bending radii of the first interferometric arm 1a and the second interferometric arm 2a in the region of the microring resonator 3 may be selected taking into account the compactness of the optical filtering device and minimizing radiation losses during the passage of radiation through the first interferometric arm 1a and the second interferometric arm 2a. Each of the first interferometric arm 1a and the second interferometric arm 2a may have a portion covered with a layer of phase change material, which is designated as sections PCM₁ and PCM₂, respectively. Each of the first interferometric arm 1a and the second interferometric arm 2a may be arranged so that at least two regions thereof are located in relatively close proximity to the microring resonator 3 to provide optical coupling between of the first interferometric arm 1a and the second interferometric arm 2a and the resonator 3. For example, FIG. 7A shows one such region, which is designated as optical coupling between 3 and 1a. Other optical coupling regions are located in similar locations in relatively close proximity to the microring resonator 3, but are not shown in FIG. 7A.

The radiation emitted by an external radiation source or directed from any other parts of the optical circuit (e.g., from a cascade of optical filters with other resonant wavelengths located on the same chip as the optical filtering device according to one or more embodiments) may enter the second waveguide 2 (in FIG. 7A—“radiation input”) and propagate along the waveguide in its electric fundamental mode TE00 (the type of this mode is shown in FIGS. 9A and 9B). The output of the mode may be either the right side of the second waveguide 2 (see FIG. 7A “first radiation output”) or the left side of the first waveguide 1 (see FIG. 7A “second radiation output”).

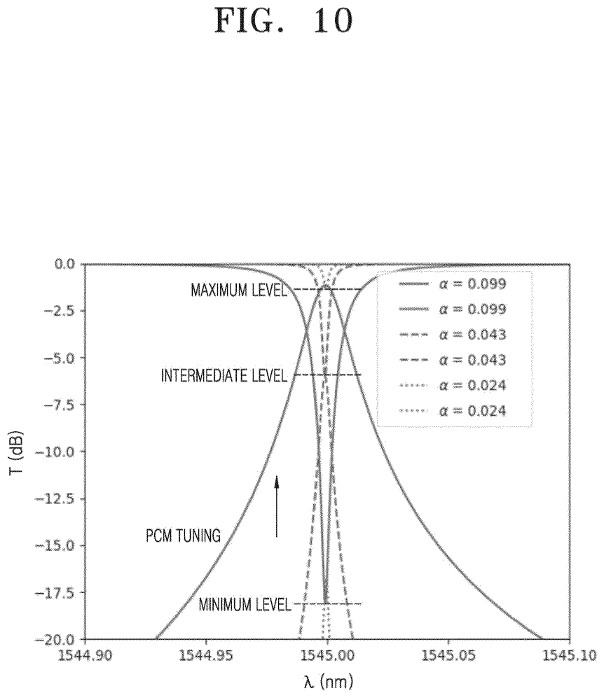

The radiation between the outputs (see FIG. 7A, first radiation output and second radiation output) may be divided in proportion according to the current state of the optical filtering device according to one or more embodiments. Division of the radiation between the outputs is clearly shown in FIG. 6A. Here, positive values of the signal on the photodetector correspond to transmission to the second waveguide 2, and negative values correspond to transmission to the first waveguide 1, which is ultimately determined by the degree of crystallization a for the PCM sections. In this case, the photodetector may include two detectors. One of the two detectors is located at the output of the second waveguide 2 (see FIG. 7A “first radiation output” on the right), and the second one is at the input of the first waveguide 1 (see FIG. 7A “second radiation output” on the left), while the detected signal is the result of subtracting the signals from the two detectors. For example, when all the incident radiation passes through the second waveguide 2, no radiation enters the first waveguide 1. When no radiation passes straight through, all the radiation may go to the first waveguide 1 (except for small losses, which are indicated in FIG. 4 as induced losses). FIG. 10 shows by upper and lower curves (the maximum level is the first case, when all the incident radiation passes straight through the waveguide and no radiation enters the first waveguide 1, and the minimum level is the second case, when no radiation passes through the second waveguide 2 and all the radiation propagates along the first waveguide 1 and exits the first waveguide 1). The output of the first waveguide 1 and the second waveguide 2 is similar to the input. The radiation may further propagate along the waveguide to other parts of the optical circuit, or be output from the chip, for example, by using the aforementioned butt-coupled fiber output method, thereafter, be directed to an external radiation detector (PIN diode or avalanche photodiode).

Optical radiation may enter the input of the second waveguide 2 (see FIG. 7A, “radiation input”) from an external radiation source. Then the radiation may propagate along the second waveguide 2 from left to right in the form of a coupling mode. In regions located in close proximity to the microring resonator 3 (see, for example, FIG. 7A “optical connection between 3 and 1a”) with the microring resonator 3 (hereinafter referred to as the optical coupling region), there may be a partial pumping of radiation from the second waveguide 2 into the microring resonator 3. Then the radiation may propagate both in the microring resonator 3 and in the second waveguide 2. At phase synchronism, these waves may constructively interfere in the optical coupling region between the microring resonator 3 and the second waveguide 2. In this case, the conditions for constructive interference may depend on the wavelength of light due to the dispersion of the refractive index of the waveguide material. Therefore, for some wavelengths, the radiation may pass straight through (maximum transmission is achieved), for others, on the contrary, all radiations propagate to the upper part of the microring resonator 3 and similarly to the first waveguide 1.

FIG. 10 shows curves illustrating the dependence of the radiation transmission at a predetermined (selected) wavelength of 1545 nm passing through the reconfigurable, optical filtering device according to one or more embodiments on the phase state of the material.

Referring to FIG. 10, in one of the states of the PCM sections (at α=0.099), the radiation near this wavelength may almost entirely propagate to the first waveguide 1, while the radiation at the remaining wavelengths from the presented range (about 1544.9 nm to about 1545.1 nm) may almost entirely propagate to the second waveguide 2.

For example, this may define the resonant transmission profile of the optical filtering device. The phase of the radiation at the required resonant wavelength passing, for example, through the first interferometric arm 1a, may coincide with the phase of the radiation that passed through the microring resonator 3. This indicates that a phase difference between the first interferometric arm 1a and optical coupling points in the optical coupling region must coincide with a multiple of 2πn (where n is an integer). Periodic dips for the selected wavelengths may occur, and the periodicity in this case may be related to the 2n multiplicity mentioned above. For example, the phase-matching conditions may be changed by reconfiguring the PCM sections, which may entail a change in the resonant transmission profile of the optical filtering device.

Various types of phase change materials may be used for the PCM sections. Phase change materials may be used based on the ability of a substance to release/absorb enough energy during a phase transition, i.e., during the transition from one state, for example, solid or liquid, to another state. According to one or more embodiments, the types of materials with the possibility of transition from an amorphous state to a crystalline state (and vice versa) under thermal action may be used.

FIG. 6B shows the amorphous (a-Sb₂S₃) and crystalline (c-Sb₂S₃) states of the PCM section according to temperature when using the Sb₂S₃ material to the PCM section according to one or more embodiments. At the same time, as shown in FIG. 6A, the gradual crystallization of the PCM may change the transmission of the optical filtering device at a selected wavelength, and simultaneously reduce the power consumption of the optical filtering device. The transmission of the optical filtering device may be changed and the power consumption thereof may be reduced because the state of each of the PCM sections may be maintained during the filter tuning process in a given way without additional adjustment or manipulation during the operation of the optical filtering device.

According to one or more embodiments, the following material parameters may be considered in the amorphous and crystalline states (a/c) of the PCM section. A refractive index (n), an absorption coefficient (k) (both values are presented for the spectral C-band near 1550 nm), a recording/rewriting time (t_{w}), erasing time (tₑ), and an energy required for switching (Eb).

1) Materials of the GST group (germanium-antimony-tellurium (GeSbTe)) are first-order phase-change materials from the group of chalcogenide glasses. GST group materials may have a refractive index in the amorphous and crystalline states (a/c): n=4.4/7.5, absorption coefficient in the amorphous and crystalline states: k=0.1/1.35, writing/rewriting time: t_{w}=20 ns, erasing time: tₑ=100 ns, and energy required for switching: E=180 pJ

2) Materials of the GSST group (germanium-antimony-selenium-tellurium (GeSbSeTe)), one example from the GSST group may be the compound Ge₂Sb₂Se₄Te₁. GSST group materials are first-order phase-change materials from the group of chalcogenide glasses. GSST group materials may have a refractive index in the amorphous and crystalline states (a/c): n=3.3/5.1, absorption coefficient in the amorphous and crystalline states: k=0.0/0.4, writing/rewriting time: t_{w}=100 ns, erasing time: tₑ=100 μs, and energy required for switching: E=5.5 pJ

3) The inorganic compound antimony selenide Sb₂Se₃ are the materials with a first-order phase transition from the group of chalcogenide glasses. The Sb₂Se₃ compound may have a refractive index in the amorphous and crystalline states (a/c): n=3.3/4.1, an absorption coefficient in the amorphous and crystalline states: k=0.0/0.0, a writing/rewriting time: t_{w}=400 ns, an erasing time: tₑ=100 μs, the energy required for switching: E=14 nJ.

The inorganic compound antimony trisulfide Sb₂S₃ are the materials with a first-order phase transition from the group of chalcogenide glasses. The Sb₂S₃ compound may have a refractive index in the amorphous and crystalline states (a/c): n=2.7/3.3, an absorption coefficient in the amorphous and crystalline states: k=0.0/0.0, a writing/rewriting time: t_{w}=500 ns, an erasing time: tₑ=2 s, and the energy required for switching: E=40 nJ.

Materials of the BTO group (barium titanate BaTiO₃) are materials with a second-order phase transition. The material of the BTO group may have a refractive index in the amorphous and crystalline states (a/c): n=2.3, an absorption coefficient in the amorphous and crystalline states: k=0.0, a writing/rewriting time: t_{w}=6 μs, an erasing time: tₑ=30 μs, and the energy required for switching: E=4.6 pJ.

GSST group materials may exhibit relatively high stability, fast reconfiguration upon exposure, and a large number of switching cycles without loss of optical properties.

Sb₂Se₃ and Sb₂S₃ compounds may be used in the optical filtering device, because they have a relatively low absorption coefficient both in the crystalline and amorphous states.

BTO group materials are relatively highly energy efficient, but their operation requires the application of a constant bias voltage and they have a relatively slow reconfiguration, and thus phase transition between stable phase states may be relatively slow.

As indicated above, the PCM sections may include various groups of materials, and may be made in the form of a continuous layer as shown in FIG. 8A, or structured as shown in FIG. 8B in the form of at least two portions of PCM material of various shapes (e.g., a circle, an ellipse, and any other shapes), and arranged in a given structured way, i.e., in the form of a pattern. Here, the intermediate portions between the portions of the PCM are portions not covered with a layer of PCM. The implementation of a structured layer of PCM material may significantly improve the stability of the material when switching between phases from amorphous to crystalline and vice versa.

A smaller volume of PCM in the PCM section may provide greater durability of the device due to less material degradation due to segregation of its constituent elements and less influence of shape distortion during melting. In addition, when using a structured PCM section in optical devices based on electronic-photonic integrated circuits (EPIC) and in other similar applications, during adjustment of the optical devices, the number of phase state switching cycles may be significantly increased compared to using PCM sections made in the form of a continuous layer. Consequently, according to one or more embodiments, such a structured implementation of the PCM section may increase the endurance of the device, reduce absorption losses during the propagation of radiation through the PCM section, and make it less susceptible to corrosion and optical distortion, but may complicate the manufacturing process.

Resonators of different shapes, for example, in the form of an ellipse, may be used in a non-volatile, reconfigurable, optical filtering device according to one or more embodiments.

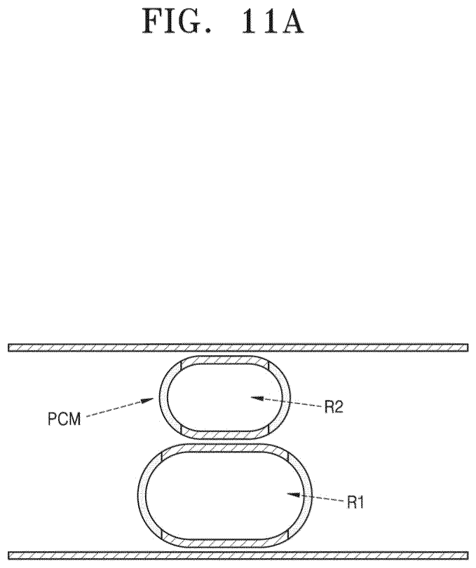

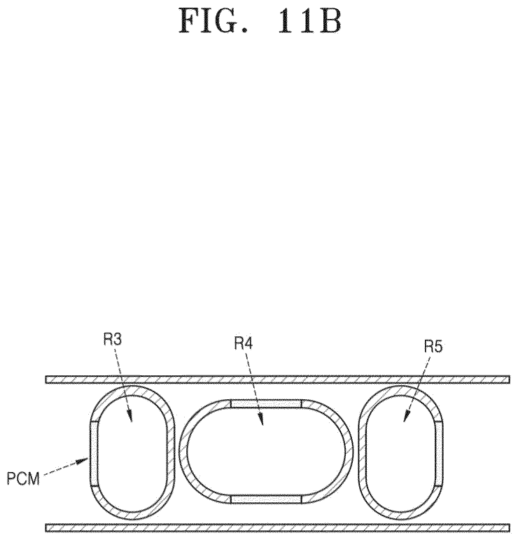

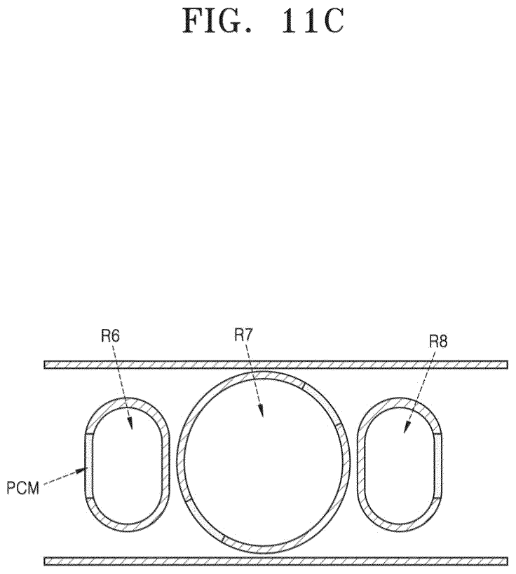

FIGS. 11A, 11B, and 11C schematically show resonators according to one or more embodiments.

Referring to FIG. 11A, the optical filtering device according to one or more embodiments may include two elliptical waveguide resonators R1 and R2 optically coupled to each other. The two elliptical waveguide resonators R1 and R2 may be located on a substrate, and each may include at least two sections of phase change material (PCM sections). The operation and processes of the optical filtering device according to one or more embodiments may be substantially identical to those of the optical filtering device including a microring resonator and interferometric arms (see FIG. 7A).

In the optical filtering device according to one or more embodiments, the radiation propagating in one of the elliptical waveguide resonator (e.g., R1) may interfere with the radiation in the other elliptical waveguide resonator R2 due to near-field optical coupling in the region of their convergence. The result of such interference may depend on the phase delay in each of the resonators, which may be regulated using the state of the PCM sections in each of the resonators. Details of the regulation of the PCM section are described with reference to FIGS. 6A and 6B.

Referring to FIG. 11B, the optical filtering device according to one or more embodiments may include three elliptical waveguide resonators R3, R4, and R5 optically coupled to each other. The three elliptical waveguide resonators R3, R4, and R5 may be located on a substrate, and each of the two side elliptical resonators may include at least one section of phase change material (PCM sections), and the central elliptical resonator may include at least two sections of phase change material (PCM sections). The operation and processes of the optical filtering device according to one or more embodiments may be substantially identical to those of the optical filtering device including a microring resonator and interferometric arms (see FIG. 7A).

In the optical filtering device according to one or more embodiments, radiation propagating in each of the elliptical waveguide resonators (e.g., R3 and R5) may interfere with radiation in the central elliptical waveguide resonator R4 due to near-field optical coupling. The result of such interference may depend on the phase delay in each of these resonators, which may be regulated using the state of the PCM sections in each of these resonators. The details of regulating the PCM section are described with reference to FIGS. 6A and 6B.

Referring to FIG. 11C, the optical filtering device according to one or more embodiments may include three elliptical resonators R6, R7, and R8 optically coupled to each other. The three elliptical resonators R6, R7, and R8 may be located on a substrate, each of side elliptical resonators R6 and R8 may include at least one section of phase change material (PCM sections), and the central ring resonator R7 may include at least two PCM sections. The operation and processes of the optical filtering device according to one or more embodiments may be substantially identical to those of the optical filtering device including a microring resonator and interferometric arms (see FIGS. 5A and 7A).

In the optical filtering device according to one or more embodiments, the radiation propagating in each of the elliptical waveguide resonators R6 and R8 may interfere with the radiation in the central elliptical waveguide resonator R7 due to near-field optical coupling in the region of convergence of the three elliptical resonators R6, R7, and R8. The result of such interference may depend on the phase delay in each of these resonators, which may be regulated using the state of the PCM sections in each of these resonators. The details of regulating the PCM section are described with reference to FIGS. 6A and 6B.

The calibration and configuration of the PCM sections and the operation of the embodiment according to FIGS. 11A, 11B, and 11C may be similar to those of the non-volatile, reconfigurable, optical filtering device according to FIGS. 5A and 7A.

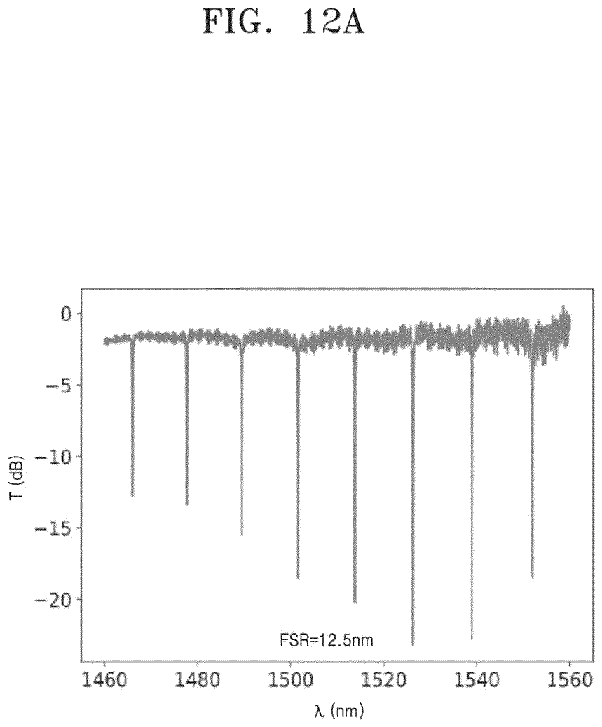

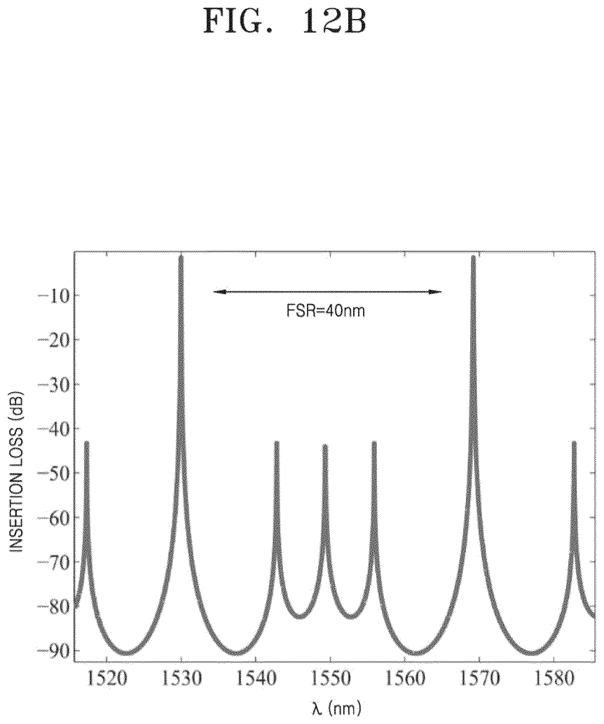

FIGS. 12A and 12B show resonant profiles of the optical filtering devices used in the ring resonator, interferometer configuration, and the configuration in which elliptical resonators are used.

FIG. 12A shows the resonant profile of the optical filtering device including a microring resonator and interferometer arms (MRR+MZI) according to one or more embodiments. Here, the X-axis represents the wavelength A, and the Y-axis represents the transmission T. For example, a distance between adjacent resonances may be determined by the FSR parameter (free spectral range) and 12.5 nm.

FIG. 12B shows the resonant profile of the optical filtering device using elliptical resonators. Here, the X-axis represents the wavelength A, and the Y-axis represents the insertion loss (insertion loss is essentially identical to the transmission of the device, as in FIG. 12A illustrates the transmission of radiation through the same waveguide (similar to the second waveguide 2 in FIG. 5A). FIG. 12B shows the propagation of radiation through the opposite waveguide (similar to the first waveguide 1 in FIG. 5A). For example, a distance between adjacent resonances may be determined by the FSR parameter (free spectral range), and 40 nm.

As may be seen from the graphs in FIGS. 12A and 12B, the FSR value may be about 3 times higher than the similar parameter of the MRR+MZI implementation, which may allow working with a denser communication channel. For example, a fixed spectral spacing between channels in a wavelength division multiplexing (WDM) system may be maintained, and more communication channels may be included in a filter.

FIGS. 9A and 9B show cross-sections of a waveguide with a PCM section according to one or more embodiments. The PCM section may include Sb₂S₃.

For example, the effective refractive index of the mode propagating in the core of the waveguide may be adjusted by partially switching the PCM section from the amorphous state (FIG. 9A) to the crystalline state (FIG. 9B) (and vice versa). The effective refractive index in the waveguide for the crystalline and amorphous states of the PCM may change by about 1%, which may cause a shift in the filter resonance. For the amorphous state, the real part of the effective refractive index is n_{eff}=2.636 (see FIG. 9A), and for the crystalline state, n_{eff}=2.660 (see FIG. 9B). In this case, in the lower right corner of in FIGS. 9A and 9B, values (i6.8e-5) and (i4.7e-4) represent the imaginary part of the effective refractive index indicating the absorption losses for the amorphous state of the PCM on the waveguide and for the crystalline state, which indicates very small absorption losses of the optical filtering device (extinction ratio less than 0.0001).

As described with reference to FIG. 5B, tuning the optical filtering device according to one or more embodiments may provide both a resonance shift and a change in its amplitude and spectral position. The optical filtering device according to one or more embodiments may individually adjust each PCM section at different portions. For example, each PCM section is individually adjusted in the first interferometric arm 1a and the second interferometric arm 2a and on the opposite portions of the microring resonator 3, and thus at one wavelength a position of the resonance is not changed simultaneously when its amplitude changes, which may ensure a given transmission of radiation in the optical filtering device.

As shown in FIG. 6A, the gradual crystallization of the PCM may change the transmission of the optical filtering device at the resonant wavelength, while simultaneously reducing the power consumption of the optical filtering device. This is because the state of each of the PCM sections during the tuning process of the optical filtering device according to one or more embodiments does not require additional thermal or injection tuning during the device operation.

For example, the property of the PCM may be used by regulating the signal transmission in the optical filtering device. For example, the signal transmission in the optical filtering device may be regulated by changing the ratio of the volume fraction of the amorphous and crystalline states of the material in a particular PCM section. The ratio of the volume fraction of the amorphous and crystalline states of the material in the PCM section may be determined by the coefficient α, indicating the proportion of the crystalline and amorphous phases in the PCM section (see FIG. 6B).

Referring to FIG. 10, the transmittance may increase with a change in the coefficient α. FIG. 10 shows curves illustrating the radiation passing through the optical filtering device. For example, the radiation at a predetermined or selected wavelength of 1545 nm passing through the second waveguide 2 (thick lines: solid at α=0.099, dashed α=0.043, dotted line at α=0.024), and reflected radiation (output) that has passed through the waveguide loop and passes through the first waveguide 1 (thin lines: solid at α=0.099, dashed α=0.043, dotted line at α=0.024) are shown.

In FIG. 10, the Y-axis represents the transmittance T (dB), and the X-axis represents the wavelength A in nm, where each of the curves on the graph demonstrates a change in the amplitude of the resonance at a selected wavelength of 1545 nm. By changing the ratio α between the crystalline and amorphous states of the PCM, the transmission level of the optical filter device may change. The transmission level may be changed from the minimum level (approximately −18 dB), through an intermediate level (approximately −6 dB) to the maximum level (approximately −1 dB). Also, as may be seen in FIG. 10, when the transmittance changes, the resonance itself and its position remain unchanged (i.e. without spectral shift), and only its amplitude may change.

The optical filtering device according to one or more embodiments may independently control the resonance in the interferometric arms of the waveguides and the microring resonator, thereby making it possible to change the signal amplitude without shifting the resonant lines in the spectrum of the optical filtering device. The optical filtering device according to one or more embodiments may significantly reduce inter-channel crosstalks during the operation of the optical filtering device and perform spectral tuning at low power consumption during the repeated use of the optical filtering device.

The optical filtering device according to one or more embodiments may be used in various optoelectronic devices based on EPIC, for example, in electronic-photonic hardware (HW) accelerators used for machine learning, for high-performance computing (HPC) applications, for artificial intelligence (AI) applications, in photonic interconnects for data centers, such as integrated photonic routers for disaggregated systems in data centers, for various types of signal processing in telecommunication systems with WDM (e.g., photonic coprocessors for distortion compensation in WDM telecommunication systems).

The optical filtering device and the method of tuning the optical filtering device according to one or more embodiments may maintain a given setting of parameters without an additional external adjustment to the optical filtering device.

The optical filtering device and the method of tuning the optical filtering device according to one or more embodiments may independently control a resonance shift with respect to a spectrum of radiation passing through the optical filtering device in the interferometric arms of the waveguide and the microring resonator.

The optical filtering device and the method of tuning the optical filtering device according to one or more embodiments may change the amplitude of a spectrum of radiation passing through the optical filtering device without shifting a resonance with respect to the spectrum in the interferometric arms of the waveguide and the microring resonator.

The optical filtering device according to one or more embodiments implemented in a small form-factor (SFF) to minimize an installation space located in an optical chip and the method of tuning the optical filtering device are provided.

The optical filtering device and the method of tuning the optical filtering device according to one or more embodiments may reduce inter-channel crosstalk in the optical filtering device in which radiation with a relatively narrow spectrum of wavelengths is used.

The optical filtering device and the method of tuning the optical filtering device according to one or more embodiments may require relatively low power consumption for performing spectral tuning during the repeated use of the optical filtering device.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. An optical filtering device comprising:
a microring resonator comprising a first region, a phase change material (PCM) being on the first region;
a first waveguide comprising a first interferometric arm and configured to receive and output radiation, the first interferometric arm comprising a second region, a PCM being on the second region; and
a second waveguide comprising a second interferometric arm and configured to receive and output radiation, the first interferometric arm comprising a third region, a PCM being on the third region,
wherein the microring resonator is between the first waveguide and the second waveguide, and a region of the first interferometric arm and a region the second interferometric arm are adjacent to the microring resonator and configured to provide optical coupling with the microring resonator,
wherein a phase of radiation of a predetermined wavelength that passes through each of the first interferometric arm and the second interferometric arm is a multiple of 2πn, where n is an integer, of a phase of radiation that passes through a region of the microring resonator between the region of the first interferometric arm and the region of the second interferometric arm configured to provide optical coupling with the microring resonator, and
wherein each of the PCM respectively on the microring resonator, the first interferometric arm, and the second interferometric arm are configured to provide a predetermined effective refractive index at the predetermined wavelength and provide at least one of a resonance shift and an amplitude change of radiation at the predetermined wavelength propagating in the first waveguide or the second waveguide.

2. The optical filtering device of claim 1, further comprising:
an external radiation source configured to generate pulsed initial radiation on the first waveguide or the second waveguide.

3. The optical filtering device of claim 1, wherein the first interferometric arm, the second interferometric arm, and a portion of the microring resonator between the region of the first waveguide and the region of the second waveguide configured to provide optical coupling with the microring resonator are Mach-Zehnder interferometers.

4. The optical filtering device of claim 1, further comprising:
a detector configured to measure an output of an optical signal at an input side or an output side of the first waveguide or the second waveguide.

5. The optical filtering device of claim 1, further comprising:
a local PIN thermoheater configured to individually adjust a phase state of each of the PCM respectively on the microring resonator, the first interferometric arm, and the second interferometric arm.

6. The optical filtering device of claim 5, wherein the PIN thermoheater comprises a voltage source connected by two electrical contacts to doped regions in a silicon layer on a substrate, and
wherein the two electrical contacts are spaced at a predetermined distance from each of the microring resonator, the first interferometric arm, and the second interferometric arm.

7. The optical filtering device of claim 5, wherein the two electrical contacts comprise a contact region configured to apply voltage from a voltage source to doped regions.

8. The optical filtering device of claim 1, wherein each of the PCM respectively on the first interferometric arm and the second interferometric arm is configured to provide a spectral resonance shift and a change in spectral amplitude, and
wherein the PCM on the microring resonator is configured to provide a spectral resonance shift.

9. The optical filtering device of claim 8, wherein the spectral resonance shifts provided in the PCM respectively on the first interferometric arm and the second interferometric arm are configured to be compensated by the spectral resonance shift provided in the PCM on the microring resonator, such that a change is provided in the spectral amplitude while a spectral position of resonance is unchanged in a process of propagating radiation of the predetermined wavelength.

10. The optical filtering device of claim 1, wherein each of the PCM respectively on the microring resonator, the first interferometric arm, and the second interferometric arm comprises a continuous PCM layer.

11. The optical filtering device of claim 1, wherein each of the PCM respectively on the microring resonator, the first interferometric arm, and the second interferometric arm has a predetermined pattern shape or an arbitrary pattern shape.

12. The optical filtering device of claim 11, wherein the predetermined pattern shape or the arbitrary pattern shape comprises a PCM divided into at least two portions.

13. The optical filtering device of claim 1, wherein the first waveguide and the second waveguide are single-mode ridge waveguides or strip waveguides.

14. The optical filtering device of claim 1, wherein the microring resonator is a closed loop ring resonator.

15. A method of tuning an optical filtering device comprising a first waveguide comprising a first interferometric arm, a second waveguide that comprises a second interferometric arm, a microring resonator between the first waveguide and the second waveguide, and phase change material (PCM) on the first waveguide, the second waveguide, and the microring resonator, the method comprising:
tuning each PCM respectively on the microring resonator, the first interferometric arm, and the second interferometric arm,
wherein the tuning of each of the PCM sections comprises:
performing thermal injection on each of the PCM to provide a predetermined partial crystallization of at least a portion of the PCM to change a phase state of at least a portion of the PCM, such that a predetermined change is caused in the effective refractive index in the PCM at a predetermined wavelength; and
determining the phase state of at least a portion of the PCM by a coefficient α indicating a proportion of a crystalline phase and an amorphous phase in at least a portion of the PCM, the coefficient α being determined by:
$$α = {v}_{a} ( {v}_{a} + {v}_{c} ) ,$$
where vₐ is a volume of the amorphous phase, and v_{c} is a volume of the crystalline phase,
wherein each of the PCM sections respectively on the microring resonator, the first interferometric arm, and the second interferometric arm is tuned to provide a predetermined effective refractive index for radiation at the predetermined wavelength to provide any one of a resonance shift and an amplitude change of radiation at the predetermined wavelength propagating in the first waveguide or the second waveguide.

16. The method of claim 15, wherein the tuning of the effective refractive index at the predetermined wavelength in each of the PCM sections is configured to change a phase velocity of propagation of an optical signal.

17. The method of claim 15, wherein thermal injection on each of the PCM is performed by applying a predetermined voltage to doped regions through two electrical contacts of the PIN thermoheater.

18. The method of claim 15, wherein the thermal injection on the PCM respectively on the microring resonator, the first interferometric arm, and the second interferometric arm is performed simultaneously or the thermal action on the PCM respectively on the microring resonator, the first interferometric arm, and the second interferometric arm is individually performed at different times.

19. The method of claim 17, wherein the predetermined voltage is in a range of 1 V to 10 V.

20. The method of claim 17, wherein the predetermined voltage is applied for 500 ns to 100 ms and with a duty cycle of up to 1 second between pulses.
